(19) United States
(12) Patent Application Publication
(10) Pub. No.: US 2005/0283814 A1
(43) Pub. Date: Dec. 22, 2005

(54) System and method for enhanced data transfer within control environments

(75) Inventors: Wayne Scott, Newport Beach, CA (US); Christopher Chambers, Stanton, CA (US)

Correspondence Address: GREENBERG TRAURIG, LLP, 77 WEST WACKER DRIVE, SUITE 2500, CHICAGO, IL, 60601-1732, US

(73) Assignee: Universal Electronics Inc., Cypress, CA (US)

(21) Appl. No.: 11/151,771

(22) Filed: Jun. 14, 2005

Related U.S. Application Data
(60) Provisional application No. 60/580,649, filed on Jun. 16, 2004.

(51) Int. Cl. H04N 7/173; H04N 7/16

(52) U.S. Cl. 725/115; 725/116; 725/145; 725/146

(57) ABSTRACT

A system and method is disclosed for enhanced data transfer methods within control environment for implementing functions on control devices. Generally, as a user browses content on a Content Server via a Control Point, various content sets will be concatenated by the Content Server based on an initial request from the Control Point, and all content in the content set will be sent as a single item from the Content Server to the Control Point, thus minimizing the number of message round trips and thus the protocol overhead needed to retrieve all content requested by the user. Information about the concatenated content set may be sent separately from the Content Server to the Control Point, or may be embedded in the content set as metadata, such that individual elements of the content set may be selectively displayed, controlled, and/or manipulated by the user via the Control Point.

### BACKGROUND

The following relates generally to control environments and, more particularly, relates to data transfer methods for implementing functions on control devices. Exemplary devices include personal digital assistants (“PDAs”), Web Tablets, touch screen remote controls, mobile phones, lap-top computers, and the like.

A typical control environment such as a home or office that includes multiple controllable appliances (eg. TV, VCR, DVD, PVR, Audio Receiver, etc) may make use of one or more control protocols (ie. Home Audio Video interoperability (“HAVi”), Universal Plug and Play (“UPnP”), etc.) in order to facilitate device interoperability, content distribution, and the passing of control based commands. In many cases it is desirable to store media based content to be distributed to the various controllable appliances on one or more “Content Servers”, and to access and control such content via one or more control devices. Each such control device is generally referred to as a “Control Point.” Each Control Point may include various functions for accessing and controlling content on the Content Server(s), including but not limited to search capabilities, display capabilities, playback capabilities, synchronization capabilities, and general control capabilities (power, volume, transport functions, etc). The underlying communication system between the Control Point(s), Content Server(s), and various controllable appliances in the control environment may be facilitated by well known methods, such as IR, RF, 1394 Firewire, Ethernet, Powerline communications, and the like.

It is desirable for a user in such control environments to be able to quickly accomplish control based functions via the Control Point(s), however, certain control protocols introduce inherent delays due to message verbosity when a user desires to access, display, and control content, even if the underlying communication system is able to accommodate high data transfer rates between the Control Point and Content Server. For example, when a user desires to preview a number of images from a Content Server on a display based Control Point (such as a wireless enabled PDA, or the like), multiple roundtrip message passes are required (at least one for each image thumbnail to be displayed on the Control Point interface) to populate the user interface on the display with the images requested by the user. Use of such image thumbnails or previews is increasingly popular as a method to provide a rich multimedia user experience. These images may for example be thumbnail representations of selectable pictures in a photo library, cover art from selectable stored audio albums, still shots representative of stored home video or movie files available for viewing, cover art for e-books available from a local or remote Content Server, locally stored catalog depictions of goods available for purchase over the Internet, etc. Accordingly, it is desired to provide a system and method that functions to package multiple content and/or control requests together, and correspondingly reduce the overall number of message round trips needed as a user searches, browses, and/or displays content residing on a Content Server via the user interface of a Control Point.

### SUMMARY

In accordance with these needs and desires, a system and method for enhanced data transfer within control environments is hereinafter described. Generally, as a user browses content on a Content Server via a Control Point, various content sets will be concatenated by the Content Server based on an initial request from the Control Point, and all content in the content set will be sent as a single item from the Content Server to the Control Point, thus minimizing the number of message round trips and thus the protocol overhead needed to retrieve all content requested by the user. Information about the concatenated content set may be sent separately from the Content Server to the Control Point, or may be embedded in the content set as metadata, such that individual elements of the content set may be selectively displayed, controlled, and/or manipulated by the user via the Control Point.

A better understanding of the objects, advantages, features, properties and relationships of the subject system and method will be obtained from the following detailed description and accompanying drawings which set forth illustrative embodiments which are indicative of the various ways in which the principles of the system and method may be employed.

### BRIEF DESCRIPTION OF THE DRAWINGS

For a better understanding of the system and method described hereinafter, reference may be had to preferred embodiments shown in the following drawings in which:

FIG. 1 illustrates a typical control environment.

FIG. 2 illustrates exemplary control points according to the current invention.

FIG. 3 illustrates the prior art method for retrieving multiple images from a content server.

FIG. 4 illustrates an exemplary image concatenation technique according to the current invention.

FIG. 5 illustrates an exemplary metadata set for referencing concatenated image set.

### DETAILED DESCRIPTION

With reference to the Figures, a system and method is described for enhanced data transfer within control environments. Generally, as described above, in response to an initial request from a Control Point based on user interaction with a user interface of the Control Point, one or more content sets will be concatenated by the Content Server and sent as a single item from the Content Server to the Control Point, thus minimizing the number of message round trips needed to retrieve all content requested by the user. While the particular data transfer method described below details a specific implementation of the subject invention as applied to image transfer and processing, it will be appreciated that, in general, the data transfer methods described may be easily implemented for other media types such as audio, video, text, etc without departing from the spirit and scope of the current invention. In addition, it will be understood that any format for the media types may be used in accordance with the subject invention without limitation.

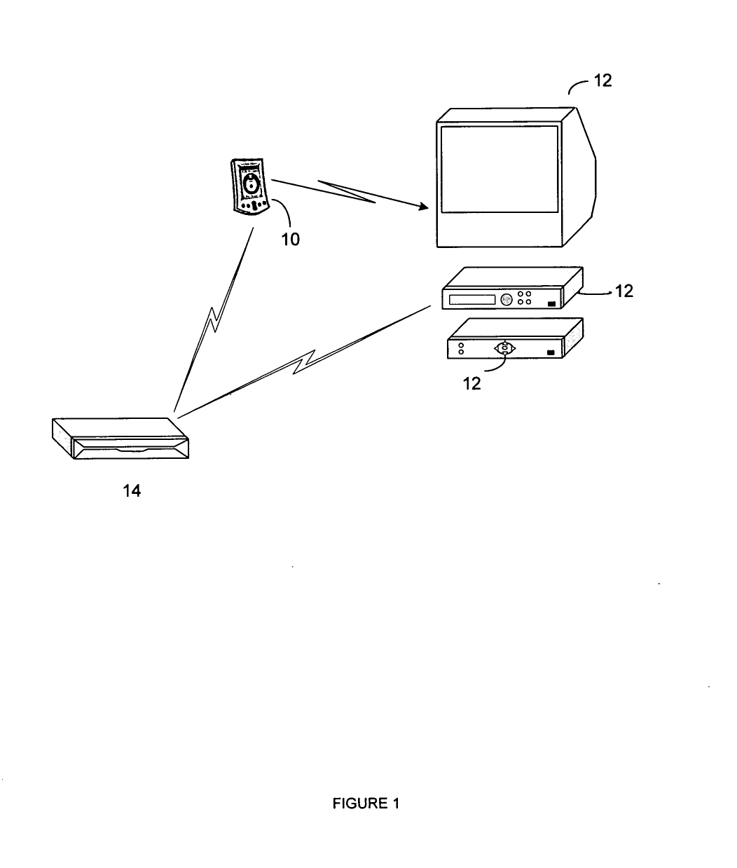

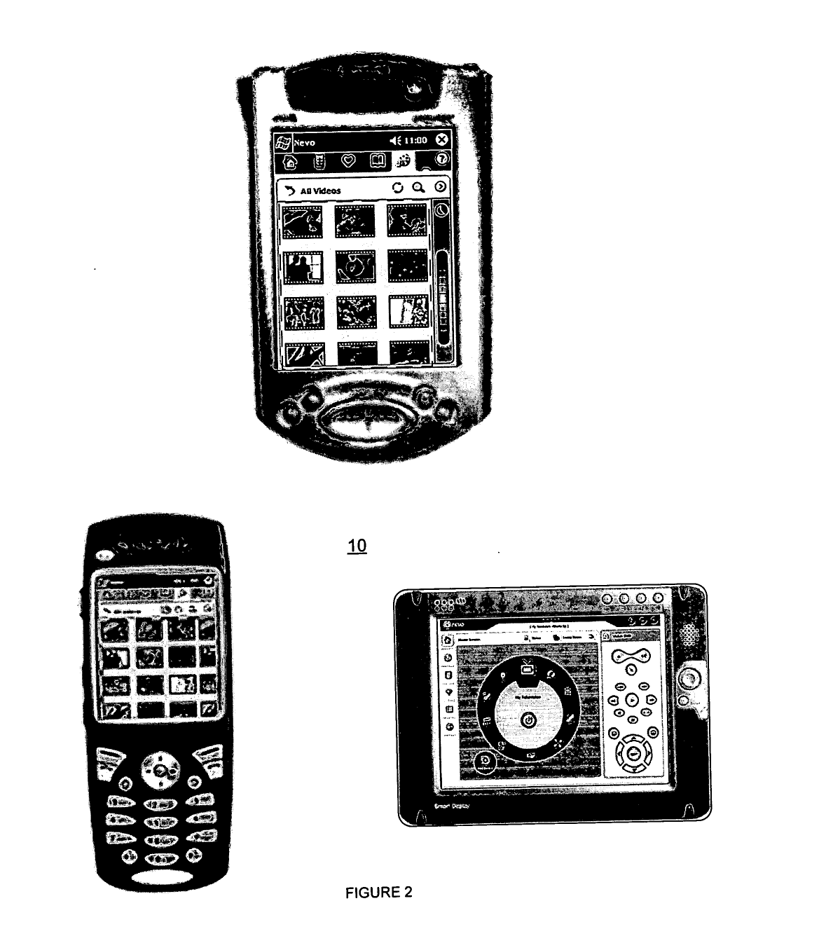

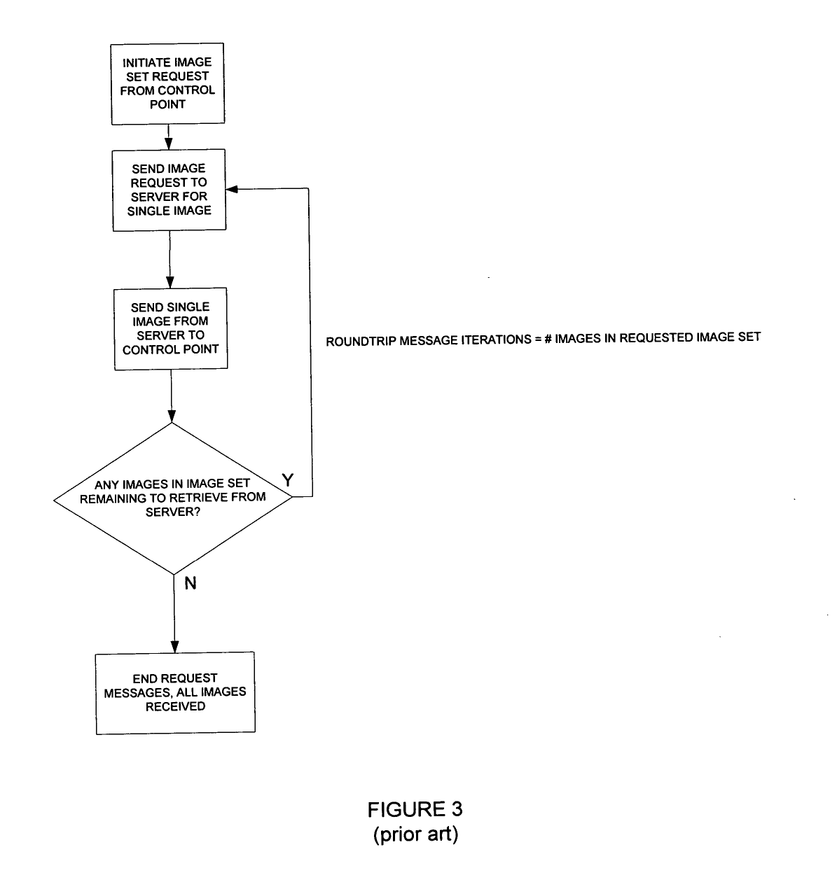

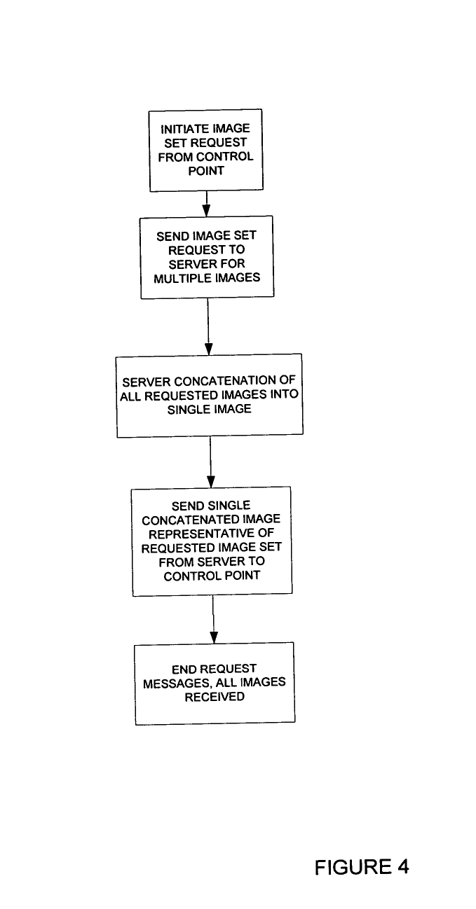

Looking now to the figures, an exemplary control environment is illustrated in FIG. 1 which includes control point 10, controllable appliances 12, and content server 14. FIG. 2 illustrates several exemplary types of control points which may be implemented in conjunction with the present invention. FIG. 3 illustrates the prior art method of retrieving a content set which results in multiple roundtrip message passes between a control point and content server. FIG. 4 illustrates an exemplary method for implementing data transfer between the control point and content server according to the current invention. By way of illustrative example, a method suitable for interaction between a wirelessly enabled PDA device acting as a Control Point and a Windows Media Center edition PC acting as a Content Server is now described. In response to user input indicating a desire to view content available on the Content Server, a client Control Point PDA device sends a request message to the server for the artwork for the next (n) items available from this Server based on the current filter (e.g. one or more of music, movies, photos, etc.) and sort criteria (e.g. genre, performer name, date, etc.). Within the request message the Control Point client specifies a desired thumbnail size and matrix layout of the return image, for example:
50 Items
30 pixels by 30 pixels
10 thumbnails by 5 thumbnails matrix
   The content server would iterate across the next 50 items scaling them appropriately for the desired thumbnail size and return a single image (300 by 150 pixels in this example) with the matrix layout requested. Since the client Control Point PDA device knows the size and order of the thumbnails that will be returned within the single image, the client may present these to the user for viewing and/or touch screen selection purposes either by selective display of concatenated thumbnails on the screen, dicing up the image matrix into the original 50 separate thumbnails and displaying all or part of them, or alternatively may simply display the entire matrix as single image and derive the desired selection based on the screen coordinates of the user's touch. In this manner multiple efficiencies are achieved: First, scaling and compression of the regular sized images into the desired thumbnail dimensions is performed locally by the Content Server prior to transmission. Since the Content Server will typically have a more powerful processor and more resources (e.g. memory) than a thin-client Control Point, the time taken to perform this process will be considerably shortened, as will the amount of data to be transferred. Second, by concatenating the requested thumbnails into a single matrixed image as described above, the number of request/response roundtrips and resultant protocol overhead required to browse the contents of the Sever are minimized. It will also be appreciated that in multi-client systems, each client may issue image formatting requests which are appropriate for its specific display capabilities. For example, such image manipulation may include resampling based on alternate color depth and schemes, dpi, resolution, etc. Additional changes such as orientation, graphical format, etc., might also be requested. However, in all cases, the complex scaling and other image manipulation is performed by the server on a connection by connection basis prior to transmission of the requested matrixed image data back to the client device.

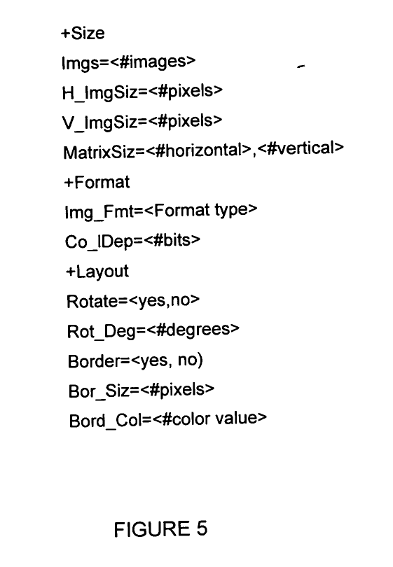

By way of further example, FIG. 5 illustrates one manner in which image formatting information may be conveyed between a Control Point client device and a Content Server. Such data may be transmitted to the Control Server as part of the initial client request, and may also be attached to the returned thumbnail matrix as descriptive metadata serving both to confirm the performance of the requested image manipulation as well as making it possible for other devices or applications to interpret and use the image matrix if desired. In the example shown the fields, in order, specify the number of thumbnail images in the matrix; horizontal size of each thumbnail in pixels; vertical size of each thumbnail in pixels; overall matrix layout (horizontal×vertical images); format of the images (JPEG, GIF, etc.); color depth in bits; orientation of image (rotate yes/no, number of degrees e.g. +90, 180, etc.); and whether a border is to be placed around each thumbnail (border yes/no, width in pixels, color). Depending on the particular protocol being used for message passes, it may be desirable to concatenate all desired request parameters in an appropriate format expected by the Content Server for that protocol. For example, when implementing a UPnP based message structure, the request can be formatted as a URL sent to the Content Server by the Control Point, e.g., using an http web address of: //AddressInformation/ImageSetInformation/ImageSizeParameters/ImageFormatParameters/I mageLayoutParameters.

The system and method of the present invention has been described above in terms of functional modules in block diagram format. It is understood that unless otherwise stated to the contrary herein, one or more functions, features, and/or steps may be integrated or accomplished in a single physical device or a software module in a software product, or one or more functions may be implemented in separate physical devices or software modules, without departing from the scope and spirit of the present invention.

For instance, it will be understood and appreciated by those skilled in the art that many different messaging structures and parameter sets may be defined and used for a particular protocol and/or media type being used within a given control environment without departing from the spirit and scope of the current invention. Additionally, the control point 10 of the present invention may be any portable control device (including but not limited to IR and/or RF based remotes, portable phones, wireless capable PDAs, etc) capable of transmitting and/or receiving content and command codes remotely to and from the appliances 12 or content server 14. Likewise, the content server 14 of the present invention may be any home control device (including but not limited to STB's, media center PC's, home automation systems, etc) capable of receiving signals representing content requests and/or command codes from the appliances and control device.

All patents cited within this document are hereby incorporated by reference in their entirety.

It is appreciated that detailed discussion of the actual implementation of each module is not necessary for an enabling understanding of the invention. The actual implementation is well within the routine skill of a programmer and system engineer, given the disclosure herein of the system attributes, functionality, and inter-relationship of the various functional modules in the system. A person skilled in the art, applying ordinary skill can practice the present invention without undue experimentation.

While various concepts have been described in detail, it will be appreciated by those skilled in the art that various modifications and alternatives to those concepts could be developed in light of the overall teachings of the disclosure. As such, the particular concepts disclosed are meant to be illustrative only and not limiting as to the scope of the invention which is to be given the full breadth of the appended claims and any equivalents thereof.

1. A server implemented method for transferring a plurality of data elements to a client device, comprising:
receiving a message from the client that specifies a parameter and the plurality of data elements to be transferred;
formatting each of the plurality of data elements in accordance with the parameter;
concatenating the formatted plurality of data elements into a single data element; and
transferring the single data element containing the formatted plurality of data elements to the client.

2. The method as recited in claim 1, wherein the single data element has the same data type as the plurality of data elements.

3. The method as recited in claim 1, wherein formatting each of the plurality of data elements in accordance with the parameter comprises scaling each of the plurality of data elements.

4. The method as recited in claim 1, wherein formatting each of the plurality of data elements in accordance with the parameter comprises compressing each of the plurality of data elements.

5. The method as recited in claim 1, wherein the plurality of data elements comprises data representative of an image.

6. The method as recited in claim 5, wherein formatting each of the plurality of data elements comprises manipulating the image represented by the data of each of the plurality of data elements.

7. A system for transferring data, comprising:
a content server in communication with a client device;
the content server receiving from the client device a message that specifies a parameter and a plurality of data elements to be transferred from the content server to the client device and, in response, functioning to format each of the plurality of data elements in accordance with the parameter, concatenate the formatted plurality of data elements into a single data element, and transfer the single data element containing the formatted plurality of data elements to the client device via a communication link; and
the client device receiving the single data element via the communication link and using the single data element to present a representation of each of the plurality of data elements.

8. The system as recited in claim 7, wherein the client device accepts input which functions to specify at least one of representations of the plurality of data elements to cause the client device to issue a request to retrieve from the content server one or more of the plurality of data elements corresponding to the representations of the plurality of data elements so specified.

9. The system as recited in claim 8, wherein the client device comprises a touch screen device having a plurality of actuation areas used to accept the input which functions to specify at least one of representations of the plurality of data elements.

10. The system as recited in claim 9, wherein the single data file comprises data indicative of an image displayed in the touch screen.

11. The system as recited in claim 10, wherein the client device functions to dice the image and then display one or more of the representations of the plurality of data elements included within the image under a respective on of the plurality of actuation areas.

12. The system as recited in claim 7, wherein the single data element has the same data type as the plurality of data elements.

13. The system as recited in claim 7, wherein each of the plurality of data elements is formatted in accordance with the parameter by scaling each of the plurality of data elements.

14. The system as recited in claim 7, wherein each of the plurality of data elements is formatted in accordance with the parameter by compressing each of the plurality of data elements.

15. The system as recited in claim 7, wherein the plurality of data elements comprises data representative of an image.

16. The system as recited in claim 15, wherein each of the plurality of data elements is formatted by manipulating the image represented by the data of each of the plurality of data elements.

17. The system as recited in claim 7, wherein the request is formatted as a URL sent to the content server by the client device.
